(19) United States
(12) Patent Application Publication
(10) Pub. No.: US 2026/0159096 A1
(43) Pub. Date: Jun. 11, 2026

(54) SENSOR FUSION VERIFICATION OF COMMAND OUTPUTS

(71) Applicant: Mercedes-Benz Group AG, Stuttgart (DE)

(72) Inventor: Suresh Govindachar, Sunnyvale, CA (US)

(21) Appl. No.: 18/972,619

(22) Filed: Dec. 6, 2024

(51) Int. Cl. B60W 50/00; B60W 60/00

(52) U.S. Cl. CPC B60W 50/0098; B60W 60/001; B60W 60/005; B60W 2420/403; B60W 2420/408; B60W 2420/54; B60W 2556/35

(57) ABSTRACT

A computing system of a vehicle can receive sensor data from a sensor suite of the vehicle. The system can execute one or more machine-learning models to perform inference on the sensor data and generate inference-based control commands to autonomously operate a set of vehicle controls of the vehicle. The system can further execute a sensor fusion module on the sensor data to generate a sensor fusion output of an exterior environment of the vehicle. The system may then determine whether a conflict exists between the inference-based control commands and the sensor fusion output.

### BACKGROUND

Machine-learning models may be used to perform inference tasks for a variety of purposes, such as autonomous navigation by robotic devices, automobiles, aircraft, and the like. End-to-end machine-learning involves direct mapping between inputs and outputs, and may use a neural network to replace a chain of some mix of machine learning and non-machine learning modules used in earlier approaches.

### SUMMARY

Machine-learning or artificial intelligence models typically generate outputs without providing an explanation or a description of internal processes that results in the outputs. Accordingly, the internal workings of machine-learning or artificial intelligence models are unknown, and therefore their outputs are unreliable. The correctness of results from a machine-learning or artificial intelligence model are highly dependent on the inputs being similar to the inputs provided during training of the model. For example, if an autonomous vehicle being operated by a machine-learning model strikes a pedestrian without providing braking inputs, the black box nature of the model prevents an auditor from tracing the model's thought process to provide an understanding of why the model struck the pedestrian. Therefore, this black box problem may create an ethical dilemma when certifying autonomous drive systems that solely rely on machine-learning or artificial intelligence models.

Autonomous or semi-autonomous vehicles perform perception and localization techniques using sensor data from a sensor suite of the vehicle, which can include any combination of cameras, LIDAR sensors, radar sensors, ultrasonic sensors, and the like. As such, the sensor data can comprise any combination of image data, radar data, LIDAR data, etc. In classical approaches, a computing system of the vehicle performs sensor fusion (e.g., using a particle filter) to combine the sensor data to dynamically generate a sensor-fused representation of the external environment of the vehicle. In particular, a particle filter can fuse the sensor data from the various sensors of the vehicle and the computing system of the vehicle can perform perception operations to, for example, detect objects of interest, generate bounding polygons for each detected object, classify the objects, and generate a motion plan for the vehicle. The result is a highly robust representation of the exterior static or dynamic environment of the vehicle (e.g., approaching 100% accuracy), including various attributes of external objects in motion (e.g., respective trajectories and velocities of other vehicles, pedestrians, bicyclists, etc.).

Alternatively, learning-based approaches for autonomous vehicle control involve the use of machine learning or artificial intelligence models in neural networks that process the sensor data to perform machine-learning inference and make decisions for driving the vehicle. Two disadvantages of learning based approaches are that the method by which the results are generated is not understandable and that the results are brittle, meaning that their correctness depends on how closely the input data matches the data used during training and even small deviations between the two can result in highly inaccurate results. These two disadvantages in learning-based approaches results in the inability to guarantee safety in the neural network's decision-making processes. To certify that a system is safe, safety engineers use a V-Model wherein the one side specifies the desired results, and the other side identifies how the system achieves those desired results. When a system contains any machine learning or artificial intelligence, a safety engineer is unable to certify that the specified results that depend on those bits of machine learning or artificial intelligence are indeed achieved.

In various examples described herein, a vehicle computing system can feed sensor data to two sub-systems that execute concurrently. One sub-system, wholly or in part, involves artificial intelligence or machine learning models performing inferences, which can generate inference-based control commands to autonomously operate a set of vehicle controls of the vehicle. The other sub-system would be devoid of any artificial intelligence and machine learning models and would typically apply a particle filter on the sensor data to generate a sensor fusion output of an exterior static or dynamic environment of the vehicle. The vehicle computing system can include a verifier module that can determine whether conflicts exist, now or in the near future (next n-seconds or milliseconds), between the inference-based control commands outputted by the machine-learning model and the sensor fusion output of the particle filter.

Accordingly, the verifier module can leverage the robustness of the sensor fusion output by the particle filter to verify, in real-time, that the decision-making by the machine-learning model is safe. If a conflict exists, then the verifier module can cause the vehicle to perform a remedial action, such as ignoring a motion plan corresponding to the inference-based control commands and/or can perform a different remedial action, such as slowing the vehicle down, handing over control to a driver or teleoperator, or maintaining a lane state, and allowing the sensor fusion module and machine-learning model to achieve a state of agreement, i.e., execution of the control commands in the world as determined by the sensor fusion module would not result in dangerous outcomes such as accidents. The inference-based commands can correspond to any operation of the vehicle, such as any combination of acceleration and deceleration commands, steering commands, braking commands, and signaling commands, which can correspond to, for example, a lane change, a decision to proceed with a right or left turn, a decision to cross an intersection, and the like.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is a block diagram depicting a computing system implementing a sensor fusion module for verifying outputs of a command generation module, according to examples described herein;

FIG. 1B is a block diagram depicting a vehicle computing system implementing a sensor fusion module for verifying inference-based commands generated by a neural network of the vehicle, according to various examples;

FIG. 2 is a block diagram illustrating an example system-in-package comprising multiple chiplets implementing fusion and safety verification of machine-learning outputs, in accordance with examples described herein;

FIG. 3A is a flow diagram describing a method of verifying command outputs using sensor fusion, according to examples described herein; and

FIG. 3B is a flow diagram describing an example method of verifying outputs of a machine-learning model, according to examples described herein; and

FIG. 4 is a block diagram that illustrates a computing system 400 upon which certain examples described herein may be implemented.

### DETAILED DESCRIPTION

In certain implementations, a computing system can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

An example of a computing system implementing machine learning is a system-in-package (SIP), which can combine multiple components of a computer or electronic system packaged as a single chip, providing a compact and efficient solution for a wide range of applications. One advantage of an SIP is its compactness and reduced complexity, since all the components are integrated onto a single chip. This reduces the need for additional circuit boards and other components, which can save space, reduce power consumption, and reduce overall cost. The components of an SIP are often referred to as chiplets, which are small, self-contained semiconductor components that can be combined with other chiplets to form the SIP.

Chiplets are designed to be highly modular and scalable, allowing for the creation of complex systems from smaller, simpler components and are typically designed to perform specific functions or tasks, such as memory, graphics processing, or input/output (I/O) functions. They may be interconnected with each other and with a main processor or controller using high-speed interfaces. Chiplets offer increased modularity, scalability, and manufacturing efficiency compared to traditional and current monolithic chip designs, as well as the ability to be tested individually before being combined into the larger system.

In accordance with examples described herein, a computer hardware topology (e.g., comprising a set of chiplets arranged on an SIP) can be tasked with executing runnables. In certain implementations, workloads programmed in an application can be executed as runnables to perform sensor data processing tasks (e.g., for autonomous driving), such as general perception, scene understanding, object detection and classification, ML inference, motion prediction and planning, and/or autonomous vehicle control tasks. In various aspects, the computing system can comprise an SIP arrangement comprising multiple chiplets for performing the sensor data processing tasks (e.g., for autonomous driving). Accordingly, the hardware topology can comprise a central chiplet of the SIP, one or more sensor data input chiplets, any number of workload processing chiplets, ML accelerator chiplets, general compute chiplets, autonomous drive chiplets, high-bandwidth memory chiplets, and interconnects between the chiplets.

In certain examples, the sensor data input chiplet obtains sensor data from the vehicle sensor system, which can include any combination of cameras, LIDAR sensors, radar sensors, ultrasonic sensors, proximity sensors, and the like. The central chiplet can comprise the shared memory and reservation table where information corresponding to workloads (e.g., workload entries) are inputted. In further examples, the set of workload processing chiplets can execute workloads as runnables using dynamic scheduling and the reservation table implemented in the shared memory of each SIP.

Upon obtaining each item of sensor data (e.g., individual images, point clouds, radar pulses, etc.), the sensor data input chiplet can indicate availability of the sensor data in the reservation table, store the sensor data in a cache, and indicate the address of the sensor data in the cache. Through execution of workloads in accordance with a set of independent pipelines, a set of workload processing chiplets can monitor the reservation table for available workloads. As provided herein, the initial raw sensor data can be referenced in the reservation table and processed through execution by an initial set of workloads by the workload processing chiplets. As an example, this initial processing can comprise stitching images to create a 360-degree sensor view of the vehicle's surrounding environment, which can enable the chiplets to perform additional workloads on the sensor view (e.g., object detection and classification tasks).

One or more embodiments described herein may be implemented on a computing system. Examples computing systems can include one or more control circuits that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), systems-in-package (SIPs), or any other control circuit. In some implementations, the control circuit(s) and/or computing system may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

In an embodiment, the control circuit(s) and other processing units may be programmed by one or more computer-readable or computer-executable instructions stored on the non-transitory computer-readable medium. The non-transitory computer-readable medium may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), and/or a memory stick. In some cases, the non-transitory computer-readable medium may store computer-executable instructions or computer-readable instructions.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit to perform one or more functional tasks. The modules and computer-readable/executable instructions may be described as performing various operations or tasks when the control circuit(s) or other hardware components execute the modules or computer-readable instructions.

In further embodiments, the computing system can include a communication interface that enables communications over one or more networks to transmit and receive data. In certain embodiments, the communication interface may be used to communicate with one or more other computing systems. The communication interface may include any circuits, components, software, etc. for communicating via one or more networks (e.g., a local area network, wide area network, the Internet, secure network, cellular network, mesh network, and/or peer-to-peer communication link). In some implementations, the communication interface may include for example, one or more of a communications controller, receiver, transceiver, transmitter, port, conductors, software and/or hardware for communicating data/information.

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### System Description

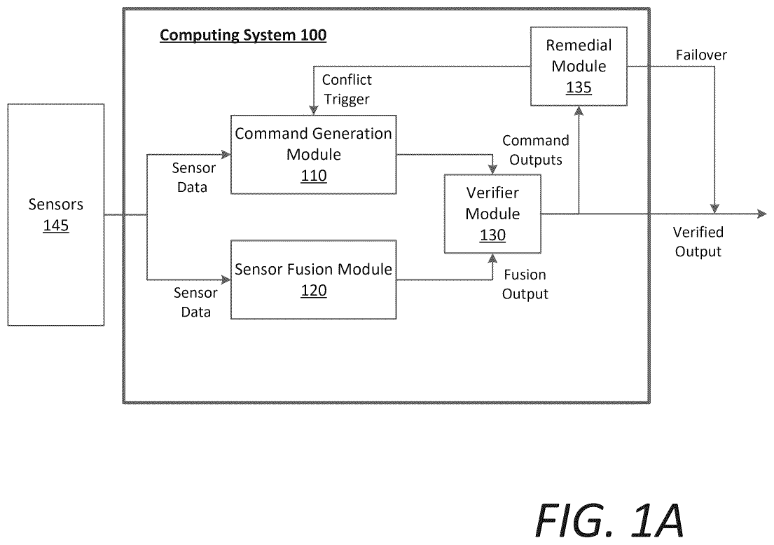

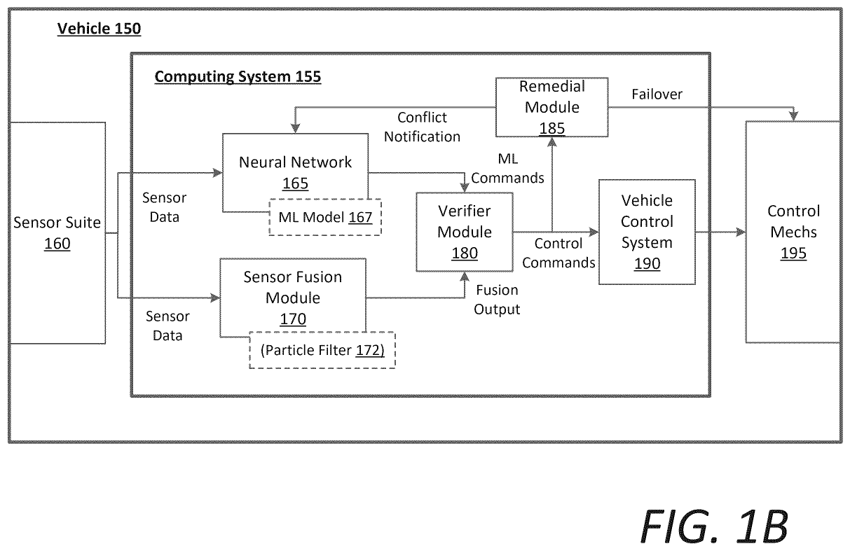

FIG. 1A is a block diagram depicting a computing system 100 implementing a sensor fusion module 120 for verifying outputs of a command generation module 110, according to examples described herein. Referring to FIG. 1A, in certain examples, the command generation module 110 can comprise any sensor data processing resource that outputs commands that may be deemed unreliable. Conversely, the sensor fusion module 120 can generate a sensor fusion output that may be deemed reliable. In certain examples, the command generation module 110 can be trained using traditional machine-learning techniques (e.g., a chain of modules) or via end-to-end techniques (e.g., learning all steps between initial input and final output). However, the command generation module 110 need not be a machine-learning module that executes a machine-learning model or artificial intelligence.

Machine-learning involves algorithms or networks or models that learn from specific datasets, with the learning (or training) resulting in establishing values for parameters of the models or coefficients of the networks and when these models are then used, they identify patterns, provide or emit descriptions and/or decisions on input data. Examples of traditional or classical techniques include decision trees, linear regression algorithms, vector machines, and other adaptive learning platforms. Input data can be processed with a chain of modules that incorporate some mix of machine learning and classing processing modules. Input data can also be processed with end-to-end machine-learning techniques comprise models trained to perform tasks from raw inputs to generate final outputs without any intermediate steps. These techniques can utilize neural networks (e.g., convolutional neural networks, recurrent neural networks, feed forward neural networks, long-short term memory networks, multilayer perceptrons, etc.) made up of a collection of nodes connected in a layered structure to, for example, classify unknown signals and perform inference tasks on input data. In either case, the command generation module 110 can be trained using supervised, unsupervised, or continuous training techniques to, for example, generate predictions and decisions, learn patterns, adjust or enhance performance, and the like.

According to examples provided herein, the computing system 100 can receive sensor data from a set of sensors 145, which can include any combination of image sensors (e.g., capturing images or recording live video), radar sensors, ultrasonic sensors, proximity sensors, LIDAR sensors, and the like. The sensor data may be processed by the command generation module 110 to produce a set of command outputs (e.g., general commands to control a set of actuators or motors, inference-based commands, etc.). It is contemplated that these outputs from the command generation module 110 can comprise any output, such as commands, predictions, conclusions, other inferences, or decisions for which the command generation module 110 was trained or programmed. As observed in the field of neural networks, machine-learning, and artificial intelligence, these outputs may be unreliable due to the black box nature of the machine-learning models, artificial intelligence, and neural networks.

In various examples, the sensor fusion module 120 of the computing system 100 can perform a classical technique of fusing the sensor data to generate a sensor-fused representation of the captured data (e.g., using a particle filter, such as a Kalman filter). Contrary to the functioning of the command generation module 110, the sensor fusion module 120 comprises a “white box” in which the output of the sensor fusion module 120 can be verified due to the underlying mathematics and algorithmic description fundamental to the particle filter. As such, the reliability of the fusion output of the sensor fusion module 120 is essentially guaranteed. For example, the particles, pixels, or return signals from the sensors 145 can be processed by the sensor fusion module 120 to produce a joint probability distribution over variables for each time-step of the sensor data, and track the estimated state of the sensed environment. The internals of the particle filter can include tunable attributes, such as an inverse sensor model, decay model, consistency attributes (e.g., with free space and the static world), resampling attributes, etc. The sensor fusion module 120 works via a prediction phase and an update phase, where the sensor fusion module 120 can produce estimates of the current state variables of the sensor data, including uncertainties, for each time-step. Once the next measurement is observed by the sensors 145 (including random noise or error), the estimates are updated using, for example, a weighted average in which more weight is given to estimates with greater certainty. As such, the sensor fusion module 120 can operate as a recursive algorithm or technique in real time, with a fusion output that converges on 100% accuracy.

In various implementations, the computing system 100 can further include a verifier module 130 that can dynamically compare, or ensure the safe-consistency or safe-coexistence between, the output of the command generation module 110 and the sensor fusion output of the sensor fusion module 120. The dynamic comparison can involve a comparison between the command outputs from the command generation module 110 and a projection into the future of the sensor fusion module 120 (e.g., a motion prediction for external entities as well as an entity controlled by the computing system 100). It is contemplated that the command generation module 110 may perform inference operations on the sensor data, and inference operations are an opaque box, impervious to human intelligence and understanding making them unreliable or suspect. The sensor fusion output of the sensor fusion module 120 is a description of traffic participants obtained via techniques that are intelligible/understandable and hence reliable. Given the description of the traffic participants, it is possible to project into the future each external (to the device under autonomous control) entity (e.g., their positions or future locations, trajectories, respective velocities, etc.). Accordingly, the verifier module 130 validates the command outputs through a dynamic comparison between the sensor fusion output from the sensor fusion module 120 and the application to the device under autonomous control the unreliable command outputs from the command generation module 110, looking for collisions or accidents.

When a conflict exists between the command outputs and the sensor fusion outputs (e.g., the command outputs in relation to the respective projections into the future as determined by the sensor fusion module 120), the verifier module 130 can trigger a remedial module 135 of the computing system 100 to perform a remedial action, such as discarding or disregarding the machine-learning output (e.g., prediction, conclusion, command, etc.), sending a notification or conflict trigger to the command generation module 110, awaiting a next time step or iteration of fusion output and machine-learning output, and verifying whether the conflict has been resolved. In some realizations, the remedial module 185 might provide feedback to the command generation module 110 (e.g., a conflict notification) that the commands resulted in a conflict, thereby perhaps causing the command generation module 110 to adapt its opaque methodology. If not, in certain examples, the verifier module 130 may generate an error notification that indicates that one of the command generation module 110, the sensor fusion module 120, or one or more sensors 145 is malfunctioning or operating outside nominal parameters. This error may be displayed on a display screen (e.g., of an administrative computer or interior display of an autonomous vehicle). In certain examples, the remedial module 135 can trigger the computing system 100 to perform a diagnostic process to identify the source of the error, and for autonomous vehicle implementations, return control to a human driver or remote teleoperator that can remotely drive the vehicle. In further examples, when a conflict is not resolvable, the remedial module 135 can trigger a failover response, which can either end autonomous operation, trigger a safety mode, hand over manual control of the autonomous machine, and the like. As provided herein, a human operator can comprise a person within the vehicle, a remote teleoperator that operates the vehicle using image data (or other sensor data) from sensors of the vehicle, or an owner of the vehicle that may operate the vehicle with a remote controller (e.g., a smartphone).

If a conflict does not exist or if a conflict has been resolved in a subsequent time step, the verifier module 130 can forward the command outputs from the command generation module 110 as a verified output, as shown in FIG. 1A. In effect, the verifier module 130 confirms the command outputs as accurate and conflict-free using the sensor fusion output from the sensor fusion module 120. As provided herein, the processes performed by the computing system 100 and the outputs of the command generation module 110 can be for any purpose, and can include the verification of output commands generated from a mix of classical and machine-learning modules or end-to-end machine learning models.

### Semi-Autonomous or Fully Autonomous Vehicle

FIG. 1B is a block diagram depicting a vehicle computing system 155 implementing a sensor fusion module 170 for verifying inference-based commands generated by a neural network 165 of the vehicle 150, according to various examples. Referring to FIG. 1B, the vehicle 150 can comprise a human-driven vehicle with an advanced driver assistance system (ADAS), fully autonomous vehicle with an autonomous drive computing system (e.g., SAE level 3 and above), or a combination of the two. In variations, the vehicle 150 can comprise a robotic vehicle (e.g., humanoid robot), aircraft, drone, marine vessel, or other autonomous or semi-autonomous vehicle. In various examples, the vehicle 150 can include a sensor suite 160 comprising any combination of LIDAR sensors, radar sensors, cameras, ultrasonic sensors, infrared sensors, other proximity sensors, etc. The vehicle 100 includes a computing system 155 that can include a neural network 165 comprising a machine-learning model 167, and a sensor fusion module 170 comprising a particle filter 172.

The machine-learning model 167 executing in the neural network 165 and the sensor fusion module 170 (e.g., which may optionally execute a particle filter 172, as shown in FIG. 1B) can be simultaneously executed on the sensor data to generate both inference-based control commands (ML commands) and a sensor fusion output, as shown in FIG. 1B. The computing system 155 can further include a verifier module 180 that dynamically determines whether a conflict or collision exists between the ML commands outputted from the machine-learning model 167 and the sensor fusion output from the sensor fusion module 170. If so, then the verifier module 130 performs a remedial action on the motion plan of the ML model 112. If not, then the verifier module 130 can forward the ML commands to the vehicle control system 170, which can autonomously operate the control mechanisms of the vehicle accordingly.

As described herein, the dynamic comparison by the verifier module 180 can involve a comparison between the ML command outputs from the neural network 165 and a projection into the future of the sensor fusion module 170 (e.g., a motion prediction for external entities in an exterior environment of the vehicle 150, as well as the predicted trajectory, velocity, and/or path of the vehicle 150). It is contemplated that the neural network 165 executing the machine learning model 167 may perform inference operations on the sensor data, and inference operations are an opaque box, impervious to human intelligence and understanding making them unreliable or suspicious. The sensor fusion output of the sensor fusion module 170 is a description of traffic participants obtained via techniques that are intelligible/understandable and hence reliable. Given the description of the traffic participants, it is possible to project into the future each external (to the device under autonomous control) entity (e.g., their positions or future locations, trajectories, respective velocities, etc.). Accordingly, the verifier module 180 validates the ML commands through a dynamic comparison between the sensor fusion output from the sensor fusion module 170 and the unreliable ML command outputs from the neural network 165, looking for collisions or accidents.

In real-world scenarios, the autonomous vehicle 150 may dynamically generate a motion plan via inference operations performed by the neural network 165, and implement a motion plan by generating control commands for a vehicle control system 190 of the vehicle 150 as the vehicle operates along a travel path. The vehicle control system 190 can directly or indirectly operate the control mechanisms 195 of the vehicle, which can include a steering system, braking system, acceleration system, power or battery harvesting system, signaling system, and the like. The verifier module 180 utilizes the sensor fusion output from the sensor fusion module 170 to verify that the inference-based, machine learning commands from the neural network 165 are not in conflict (e.g., that the motion predictions of the vehicle 150 and each of the entities external to the vehicle will not collide or get within a prohibited or dangerous proximity at a projected future time). Thus, the control commands forwarded to the vehicle control system 190 are verified using a guaranteed approach, as provided herein.

When a conflict exists, as described herein, the verifier module 180 can trigger a remedial module 185 to perform a remedial action, such as discarding or disregarding the inference-based control commands, sending a conflict notification back to the neural network 165 indicating that a conflict exists, awaiting a next time step or iteration of fusion output and machine-learning commands, and/or verifying whether the conflict has been resolved in a next time step. For example, in certain implementations, the remedial module 185 can provide feedback to the neural network 165 indicating that the ML commands have resulted in a conflict, which may cause the neural network 165 to adapt its opaque methodology to resolve the conflict.

In a driving scenario, the inference-based commands outputted by the neural network 165 can comprise a lane change action, a turning action, a proceed action (e.g., through a stop sign, traffic signal, crosswalk, or emergency vehicle), a pull-over action (e.g., to make a passenger pickup, drop-off, allow emergency vehicles to pass, etc.), a parking action or disembarking action, a stopping action, a signaling action, a swerving action, a yielding action, and the like. Each of these actions can be embodied in a motion plan of the neural network 165, which can determine the layered actions of the vehicle 150 for the next n seconds (e.g., the projected future time). The motion plan can include an overall route to a destination as well as a more immediate plan to progress along the route, which can comprise any and all of the actions described above.

Each action can be implemented using the inference-based commands from the neural network 165. However, according to examples described herein, when an inference-based command conflicts with the sensor fusion output of the particle filter 172 executed by the sensor fusion module 170, the verifier module 180 can cause the command to be ignored or canceled, and trigger the remedial module 185 to perform a remedial action. In some aspects, the remedial module 185 can provide the neural network 165 with a conflict notification, which can include a source of the conflict within the sensor fusion output, such as a potential collision object (e.g., a vehicle, pedestrian, or object unidentified or misidentified by the neural network 165). In such aspects, the neural network 165 can self-resolve the conflict and update the inference-based commands, which can then be verified by the verification module 180.

In variations, when a conflict exists, the verifier module 180 can override the inference-based command from the neural network 165 (e.g., cancel a lane change or acceleration action, cause the vehicle to slow down and maintain a trajectory within a current lane, etc.). Upon overriding the inference-based command, the verifier module 180 can perform a comparison of the next outputs from the neural network 165 and sensor fusion module 170, determine that no conflict exists, and can forward the verified control commands to the vehicle control system 190 for execution. Accordingly, it is contemplated that the vast majority of conflicts may be self-resolved in this manner, providing the autonomous or semi-autonomous vehicle 150 with an additional safety layer.

If the conflicts persist between the inference-based commands and the sensor fusion output, as provided herein, the verifier module 180 may generate, for example, an error notification that indicates that one of the machine-learning model 167, the particle filter 172, or one or more sensors of the sensor suite 160 is malfunctioning or operating outside nominal parameters. This error may be displayed on a display screen within the interior of the autonomous vehicle. In certain examples, the remedial module 185 can trigger the computing system 155 to perform a diagnostic process to identify the source of the error and attempt to self-resolve the conflict. In further examples, the remedial module 185 can trigger a failover, which can provide a notification to a passenger of the vehicle or a teleoperator to take over driving control of the vehicle 150, or can trigger the vehicle control system 190 to pull the vehicle over and park the vehicle in a safe location.

As such, the vehicle computing system 155 provided in FIG. 1B comprises an autonomous or semi-autonomous vehicle implementation of the computing system 100 described with respect to FIG. 1A. As shown in FIG. 1B, the sensor fusion module 170 (e.g., executing a particle filter 172) operates simultaneously with the neural network 165 executing the machine-learning model 167, and the verifier module 180 ensures that inference-based commands—perceived to be unreliable due to the black box nature of machine-learning and artificial intelligence —are dynamically verified such that the control commands ultimately executed by the vehicle control system 190 are safe for both passengers of the vehicle 150 and any entities external to the vehicle 150.

### System-in-Package

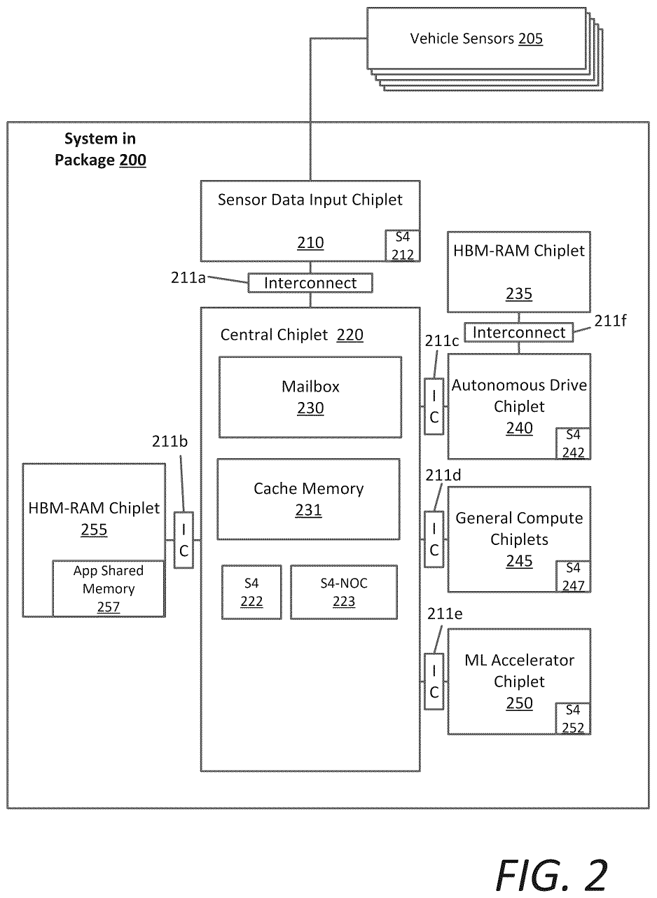

FIG. 2 is a block diagram illustrating an example system-in-package (SIP) 200 comprising multiple chiplets implementing fusion and safety verification of machine-learning outputs, in accordance with examples described herein. According to various implementations, the computing systems 100, 155 described with respect to FIGS. 1A and 1B can be implemented on the SIP 200 shown in FIG. 2, which can comprise various chiplets, such as a sensor data input chiplet 210, a central chiplet 220 comprising a mailbox 230, one or more high-bandwidth memory (HBM) chiplets 235, 255, one or more general compute chiplets 245, a machine-learning accelerator chiplet 250, and an autonomous drive chiplet 240.

The example SIP 200 shown in FIG. 2 can include additional components, and the components of the system-in-package 200 may be arranged in various alternative configurations other than the example shown. Thus, the system-in-package 200 of FIG. 2 is described herein as an example arrangement for illustrative purposes and is not intended to limit the scope of the present disclosure in any manner. In certain implementations, the hardware components and arrangement shown in FIG. 2 can be comprised in a given hardware topology for compute task optimization, as described throughout the present disclosure.

Referring to FIG. 2, a sensor data input chiplet 210 of the SIP 200 can receive sensor data from various vehicle sensors 205 of the vehicle. These vehicle sensors 205 can include any combination of image sensors (e.g., single cameras, binocular cameras, fisheye lens cameras, etc.), LIDAR sensors, radar sensors, ultrasonic sensors, proximity sensors, and the like. The sensor data input chiplet 210 can automatically dump the received sensor data as it is received into a cache memory 231 of the central chiplet 220. The sensor data input chiplet 210 can also include an image signal processor (ISP) responsible for capturing, processing, and enhancing images taken from the various vehicle sensors 205. The ISP takes the raw image data and performs a series of complex image processing operations, such as color, contrast, and brightness correction, noise reduction, and image enhancement, to create a higher-quality image that is ready for further processing or analysis by the other chiplets of the SIP 200. The ISP may also include features such as auto-focus, image stabilization, and advanced scene recognition to further enhance the quality of the captured images. The ISP can then store the higher-quality images in the cache memory 231.

In some aspects, the sensor data input chiplet 210 publishes identifying information for each item of sensor data (e.g., images, point cloud maps, etc.) to a mailbox 230 of a central chiplet 220, which acts as a central mailbox for synchronizing runnables for the various chiplets. The identifying information can include details such as an address in the cache memory 231 where the data is stored, the type of sensor data, which sensor captured the data, and a timestamp of when the data was captured.

To communicate with the central chiplet 220, the sensor data input chiplet 210 transmits data through an interconnect 211a. Interconnects 211a-f each represent die-to-die (D2D) interfaces between the chiplets of the SIP 200. In some aspects, the interconnects include a high-bandwidth data path used for general data purposes to the cache memory 231 and a high-reliability data path to transmit functional safety and scheduler information to the mailbox 230. As provided herein, the high-reliability data paths that facilitate the functional safety (FuSa) and health monitoring communications comprise a high safety level (e.g., ASIL-D), which is represented in FIG. 2 by S4 212 of the sensor data input chiplet 210, S4 222 of the central chiplet 222, S4-network-on-chip (NOC) 223 of the central chiplet 220, S4 242 of the autonomous drive chiplet 240, S4 247 of the general compute chiplet(s) 245, and S4 252 of the ML accelerator chiplet 250.

Depending on bandwidth requirements, an interconnect may include more than one die-to-die interface. For example, interconnect 211a can include two interfaces to support higher bandwidth communications between the sensor data input chiplet 210 and the central chiplet 220. In one aspect, the interconnects 211b,f implement a memory controller interface and the interconnects 211a,c-e implement the Universal Chiplet Interconnect Express (UCIe) standard and communicate through an indirect mode to allow each of the chiplets to access remote memory as if it were local memory. This is achieved by using a specialized Network on Chip (NoC) Network Interface Unit (NIU) (allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the SIP 200 can include additional chiplets that can store, alter, or otherwise process the sensor data cached by the sensor data input chiplet 210. The SIP 200 can include an autonomous drive chiplet 240 that can perform the perception, sensor fusion, trajectory prediction, and/or other autonomous driving algorithms of the autonomous vehicle. The autonomous drive chiplet 240 can be connected to a dedicated HBM-RAM chiplet 235 in which the autonomous drive chiplet 240 can publish all status information, variables, statistical information, and/or processed sensor data as processed by the autonomous drive chiplet 240. As provided herein, the autonomous drive chiplet 240 can therefore implement the sensor fusion and facilitate verification of inference-based commands outputted by the machine-learning and/or artificial intelligence aspects of the SIP 200.

In various examples, the SIP 200 can further include a machine-learning (ML) accelerator chiplet 240 that is specialized for accelerating AI workloads, such as image inferences or other sensor inferences using machine learning, in order to achieve high performance and low power consumption for these workloads. The ML accelerator chiplet 240 can include an engine designed to efficiently process graph-based data structures, which are commonly used in AI workloads, and a highly parallel processor, allowing for efficient processing of large volumes of data. The ML accelerator chiplet 240 can also include specialized hardware accelerators for common AI operations such as matrix multiplication and convolution as well as a memory hierarchy designed to optimize memory access for AI workloads, which often have complex memory access patterns.

The general compute chiplets 245 can provide general purpose computing for the system-on-chip 200. For example, the general compute chiplets 245 can comprise high-powered central processing units and/or graphical processing units that can support the computing tasks of the central chiplet 220, autonomous drive chiplet 240, and/or the ML accelerator chiplet 250.

In various implementations, the mailbox 230 can store programs and instructions for performing autonomous driving tasks. The mailbox 230 of the central chiplet 220 can further include a reservation table that provides the various chiplets with the information needed (e.g., sensor data items and their locations in memory) for performing their individual tasks. The central chiplet 220 also includes the large cache memory 231, which supports invalidate and flush operations for stored data.

Cache miss and evictions from the cache memory 231 are sent by a high-bandwidth memory (HBM) RAM chiplet 255, which can include a, application-shared memory 257, connected to the central chiplet 220. The HBM-RAM chiplet 255 can include status information, variables, statistical information, and/or sensor data for all other chiplets, and may be accessed by multiple chiplets of the SIP 200. In certain examples, the information stored in the HBM-RAM chiplet 255 can be stored for a predetermined period of time (e.g., ten seconds) before deleting or otherwise flushing the data. For example, when a fault occurs on the autonomous vehicle, the information stored in the HBM-RAM chiplet 255 can include all information necessary to diagnose and resolve the fault. Cache memory 231 keeps fresh data available with low latency and less power required compared to accessing data from the HBM-RAM chiplet 255.

As provided herein, the mailbox 230 can comprise a mailbox architecture in which a reflex program comprising a suite of instructions is used to execute workloads by the central chiplet 220, general compute chiplets 245, and/or autonomous drive chiplet 240. In certain examples, the central chiplet 220 can further execute a functional safety (FuSa) program using the high-reliability network (e.g., represented by S4 212, S4 242, S4 247, S4 252, S4 222, and S4-NOC 223) that operates to compare and verify output of respective pipelines to ensure consistency in the ML inference operations.

In various implementations, the machine-learning model may be executed using the central chiplet 220, general compute chiplet(s) 245, and/or accelerator chiplet 250 whereas the particle filter can be implemented on the autonomous drive chiplet 240. The verifier module 130, 180 described with respect to FIGS. 1A and 1B may be implemented in the central chiplet 220, which can receive the outputs of machine-learning within the SIP 200 as well as the sensor fusion performed by the autonomous drive chiplet 240. As described herein, the verifier module 130, 180 can be embodied as a verification program in the central chiplet 220 that determines whether a conflict exists between (i) the machine-learning output of the ML accelerator chiplet 250 and/or general compute chiplet(s) 245, and (ii) the sensor fusion output of the autonomous drive chiplet 240, as described throughout the present disclosure.

While the SIP 200 described with respect to FIG. 2 can implement the verifier modules 130, 180 shown and described with respect to FIGS. 1A and 1B, it is contemplated that these verifier modules may be implemented on any computing system that performs general purpose computing, machine learning and/or artificial intelligence on any data source. Thus, the methods described throughout the present disclosure may be performed on front-end computing devices (e.g., personal computers, vehicle computing systems, etc.) or backend computing system, such as servers, data centers, data clusters, and the like.

### Methodology

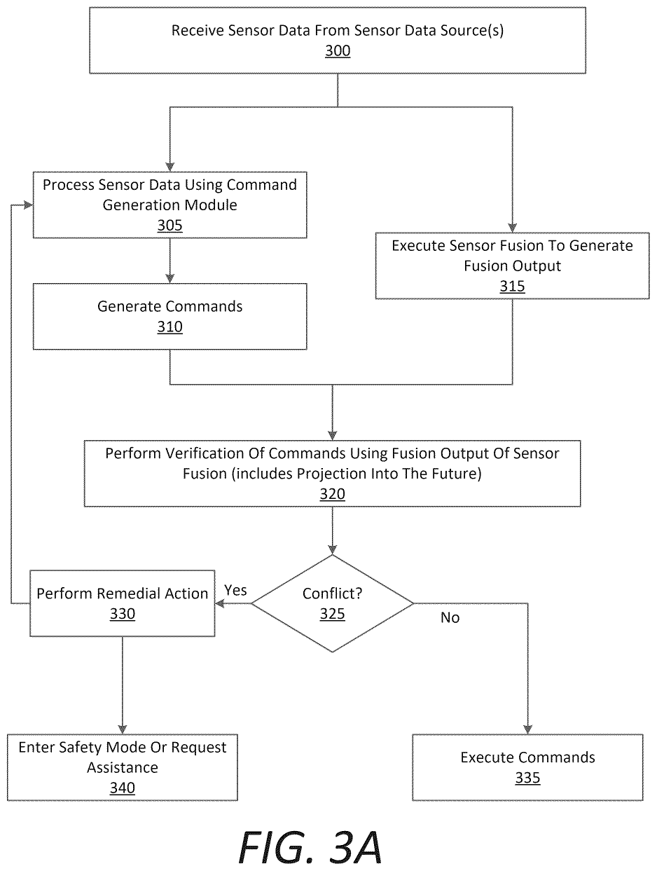

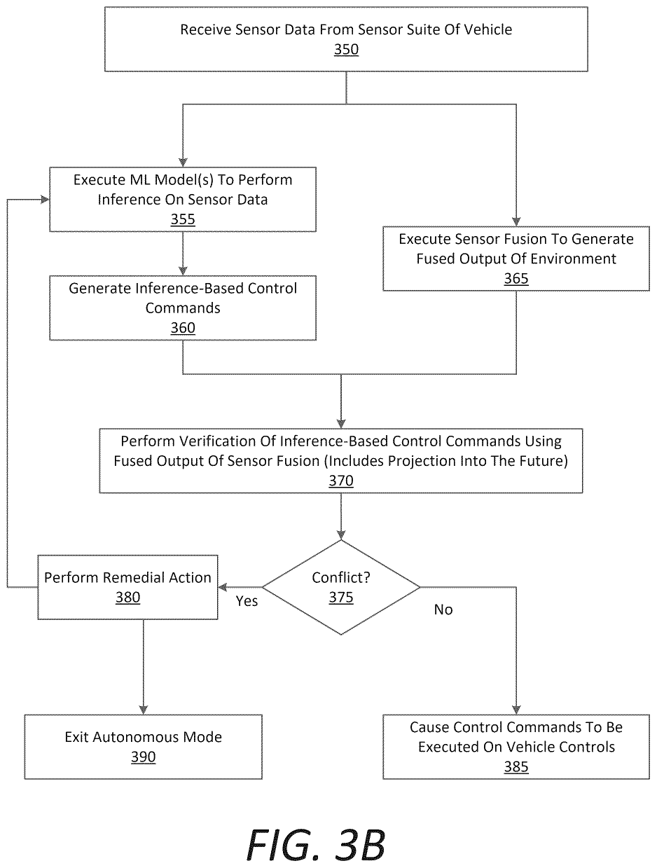

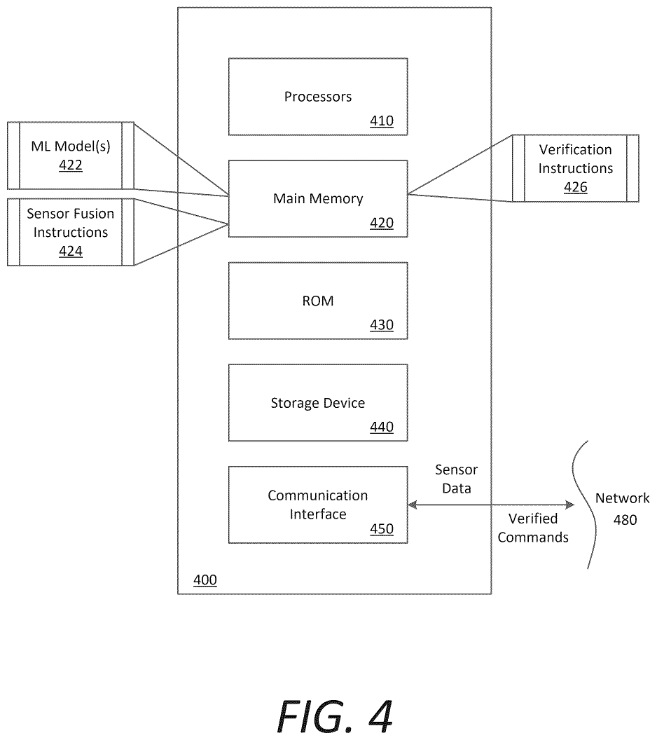

FIG. 3A is a flow diagram describing a method of verifying command outputs, according to examples described herein. FIG. 3B is a flow diagram describing an example method of verifying outputs of a machine-learning model in a vehicle implementation, according to examples described herein. In the below descriptions of FIGS. 3A and 3B, reference may be made to reference characters representing various features as shown and described with respect to FIGS. 1A, 1B, and/or 2. Furthermore, the methods described in connection with FIGS. 3A and 3B may be performed by an example computing system 100, 155 as shown and described with respect to FIGS. 1A and 1B, a system-in-package (SIP) 200 as shown and described with respect to FIG. 2, and/or any computing device, server, or collection of servers implementing general purpose computing, machine learning and/or artificial intelligence (e.g., such as computing system 400 shown in FIG. 4 and described below).

Referring to FIG. 3A, a computing system 100 can include a sub-system that implements a command generation module 110 (e.g., programmed module with unreliable command outputs) or one or more machine learning models. The computing system 100 can further comprise a sub-system that implements a sensor fusion module 120. At block 300, the computing system 100 can receive data from one or more sensor data sources 145. At block 305, the computing system 100 can process the sensor data using a command generation module 110. At block 310, the command generation module 110 may then generate a set of commands. As provided herein, the set of commands can comprise commands to implement a motion plan for a vehicle, robot, drone, marine vessel, or any other machine. It is contemplated that the command generation module 110 can execute one or more machine learning model(s) that may be executed on all received sensor data or a portion of the received sensor data, and thus inference-based outputs by the command generation module may be generated based on the machine-learning model(s) being executed on all the received data or any portion of the received data.

At block 315, the computing system 100 may also execute a sensor fusion module 120 on the received sensor data to generate a sensor fusion output (e.g., a known safe output). As provided herein, the sensor fusion output has a verifiable reliability, and can involve a projection into the future of an entity being controlled by the command generation module 110 and any entities external to the controlled entity). At block 320, the computing system 100 can perform verification of the commands outputted by the command generation module 110 using the sensor fusion output of the sensor fusion module 120. At decision block 325, the computing system 100 may then determine whether a conflict exists between the command outputs and the sensor fusion output. If so, then at block 330, a verifier module 130 of the computing system 100 can perform one or more remedial actions, as described throughout the present disclosure. In certain examples, the computing system 100 can repeat a loop and continue to process sensor data using the command generation module, at block 305, and proceed again through blocks 310, 320, and 325 to determine whether a conflict exists. In certain implementations, when a conflict persists, then upon performing the remedial action, at block 330, the computing system 100 can enter a safety mode or request assistance, at block 340. Conversely, if no conflict exists, then at block 335, the verifier module 130 of the computing system 100 can emit the verified-as-being-correct command outputs it had received from the command generation module 110.

FIG. 3B is a flow diagram describing an example method of verifying outputs of a machine-learning model in a vehicle implementation, according to examples described herein. For example, a vehicle computing system 155 of FIG. 1B and/or a SIP 200 of FIG. 2 can perform the steps described with respect to FIG. 3B. Referring to FIG. 3B, at block 350, a vehicle computing system 155 can receive sensor data from a sensor suite 160 of the vehicle 150. At block 355, the vehicle computing system 155 can execute one or more machine learning models 167 to perform inference operations on the sensor data. At block, 360, the machine learning model(s) 167 may then generate inference-based control commands based on the inference operations.

In conjunction, at block 365, the vehicle computing system 155 can execute a sensor fusion module 170 (e.g., executing a particle filter 172) that performs sensor fusion on the sensor data to generate a sensor fused output of an exterior static or dynamic environment of the vehicle 150. In various examples, at block 370, the vehicle computing system 155 can perform verification of the inference-based control commands using the sensor fusion output of the sensor fusion module 170. At decision block 375, the vehicle computing system 155 can determine whether a conflict exists between the inference-based control commands and the sensor fusion output. If so, then at block 380, the vehicle computing system 155 can perform a remedial action, as described throughout the present disclosure. In further examples, the computing system 100 can repeat the loop and continue to process sensor data using machine-learning model, at block 355, and proceed again through blocks 360, 370, and 375 to determine whether a conflict exists.

As described herein, the remedial action can involve ignoring a motion plan corresponding to the inference-based control commands, informing the command generation module, and/or another remedial action, such as slowing the vehicle down, handing over control to a driver or teleoperator, maintaining a lane state, and/or awaiting a next time step to allow the sensor fusion module 170 (e.g., the particle filter 172) and machine-learning model 167 to achieve a state of agreement. Various other examples of remediation are described herein. For example, if a conflict persists over one or more iterations, the remedial module 185 can perform remedial actions, such as maintaining a lane-following state and canceling a prepared action by the neural network 165 In further examples, at block 390, the remedial module 185 can cause the vehicle to pull over to a safe location and maintain a stopped state, park the vehicle, transmit a conflict notification (e.g., to the command generation module or backend computing system or to a teleoperator), and/or exit autonomous mode, handing control of the vehicle to a human driver or remote teleoperator.

In various scenarios, it is contemplated that sequential time steps will self-resolve the conflict. When no conflict exists, then at block 385, the vehicle computing system 155 can cause the verified inference-based control commands to be executed on the various control mechanisms 195 of the vehicle 150. For example, a verifier module 180 can forward the verified inference-based control commands to a vehicle control system 190 of the vehicle 150 to execute the motion plan.

### Example Computing System Hardware Diagram

FIG. 4 is a block diagram that illustrates a computing system 400 upon which examples described herein may be implemented. A computing system 400 can be implemented on, for example, a server or combination of servers. For example, the computing system 400 may be implemented as part of a network service, such as described in FIGS. 1A through 3B. In the context of FIGS. 1A and 1B, the computing system 100, 155 may be implemented using a computing system 400 such as described by FIG. 4. The computing systems 100, 155 may also be implemented using a combination of multiple computing systems 400 as described in connection with FIG. 4.

In one implementation, the computing system 400 includes processing resources 410, a main memory 420, a read-only memory (ROM) 430, a storage device 440, and a communication interface 450. The computing system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computing system 400 may also include the ROM 430 or other static storage device for storing static information and instructions for the processor 410. A storage device 440, such as a magnetic disk, optical disk, or solid-state drive (SSD), is provided for storing information and instructions.

The communication interface 450 enables the computing system 400 to communicate with one or more networks 480 (e.g., cellular network) through use of the network link (wireless or wired). Using the network link, the computing system 400 can communicate with one or more computing devices, one or more servers, and/or one or more self-driving vehicles. In various examples, the main memory 420 may store one or more machine learning models 422 (or command generation instructions that do not involve machine learning, but are unreliable in nature) that may be executed by the processors 410 to perform machine-learning inference on sensor data received over network 480 (e.g., a UCIe interconnect). Additionally, the main memory 420 can store sensor fusion instructions 424 for execution by the processors 410 for generating a sensor fusion output based on the received data (e.g., using a particle filter). In further examples, the main memory 420 may store verification instructions 426 that can compare the outputs of the machine-learning model(s) 422 and the sensor fusion to verify the results of the machine-learning model(s) 422, as described throughout the present disclosure.

Examples described herein are related to the use of the computing system 400 for implementing the techniques described herein. According to one example, those techniques are performed by the computing system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the processes and steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system of a vehicle, comprising:
one or more processors; and
a memory storing instructions that, when executed by the one or more processors, cause the computing system to:
receive sensor data from a sensor suite of the vehicle;
execute one or more machine-learning models to perform inference on the sensor data and generate inference-based control commands to autonomously operate a set of vehicle controls of the vehicle,
execute a sensor fusion module on the sensor data to generate a sensor fusion output of an exterior environment of the vehicle;
determine whether a conflict exists between the inference-based control commands and the sensor fusion output of the sensor fusion module;
when a conflict exists between the inference-based control commands and the sensor fusion output of the sensor fusion module, cause the vehicle to perform a remedial action; and
when a conflict does not exist between the inference-based control commands and the sensor fusion output of the sensor fusion module, execute a motion plan corresponding to the inference-based control commands.

2. The computing system of claim 1, wherein the remedial action comprises stopping the vehicle at a safe location.

3. The computing system of claim 1, wherein the remedial action comprises exiting an autonomous mode and handing control of the vehicle to a human operator.

4. The computing system of claim 1, wherein executing the motion plan comprises transmitting the inference-based control commands to a vehicle control system of the vehicle to autonomously operate the set of vehicle controls in accordance with the motion plan.

5. The computing system of claim 1, wherein the sensor suite of the vehicle comprises any combination of one or more cameras, one or more radar sensors, one or more LIDAR sensors, and one or more ultrasonic sensors.

6. The computing system of claim 1, wherein the one or more machine-learning models are executed in a neural network comprised of one or more chiplets of a system-in-package of the computing system.

7. The computing system of claim 1, wherein the sensor fusion module executes a particle filter on the sensor data to generate the sensor fusion output.

8. A method of verifying commands, the method being performed by one or more processors of a computing system, and comprising:
receiving sensor data from one or more sensors;
executing command generation module to process the sensor data and generate commands;
executing a sensor fusion module on the sensor data to generate a sensor fusion output;
determining whether a conflict exists between the commands and the sensor fusion output; and
at a first time step, when a conflict exists between the commands and the sensor fusion output, performing a remedial action.

9. The method of claim 8, wherein the remedial action comprises triggering a safety mode on the computing system.

10. The method of claim 8, further comprising:
at a second time step, when a conflict does not exist between the commands and the sensor fusion output, implementing the commands.

11. The method of claim 10, wherein the commands comprise inference-based control commands for an autonomous vehicle, and wherein implementing the commands comprises transmitting the inference-based control commands to a vehicle control system of the autonomous vehicle.

12. The method of claim 11, wherein the autonomous vehicle comprises a sensor suite that transmits the sensor data to the command generation module and the sensor fusion module of the vehicle.

13. The method of claim 12, wherein the sensor suite comprises any combination of one or more cameras, one or more radar sensors, one or more LIDAR sensors, and one or more ultrasonic sensors.

14. The method of claim 11, wherein the remedial action comprises at least one of: disregarding the commands, awaiting a next time step, determining whether a next set of commands from the command generation module and a next sensor fusion output from the sensor fusion module are in a state of agreement, providing a notification to a passenger of the autonomous vehicle to take over control, handing over control of the autonomous vehicle to a human operator, or parking the autonomous vehicle in a safe location.

15. An autonomous vehicle comprising:
a sensor suite;
a set of vehicle controls;
a vehicle control system to autonomously operate the set of vehicle controls; and
a system-in-package comprising a plurality of chiplets that perform operations comprising:
receiving sensor data from the sensor suite;
executing one or more machine-learning models to perform inference on the sensor data and generate inference-based control commands to autonomously operate the set of vehicle controls;
executing a sensor fusion module on the sensor data to generate a sensor fusion output of an exterior environment of the autonomous vehicle;
determining whether a conflict exists between the inference-based control commands and the sensor fusion output of the sensor fusion module;
when a conflict exists between the inference-based control commands and the sensor fusion output of the sensor fusion module, causing the vehicle to perform a remedial action; and
when a conflict does not exist between the inference-based control commands and the sensor fusion output of the sensor fusion module, executing a motion plan corresponding to the inference-based control commands.

16. The autonomous vehicle of claim 15, wherein the remedial action comprises stopping the vehicle at a safe location.

17. The autonomous vehicle of claim 15, wherein the remedial action comprises exiting an autonomous mode and handing control of the vehicle to a human operator.

18. The autonomous vehicle of claim 15, wherein executing the motion plan comprises transmitting the inference-based control commands to a vehicle control system of the vehicle to autonomously operate the set of vehicle controls in accordance with the motion plan.

19. The autonomous vehicle of claim 15, wherein the sensor suite of the vehicle comprises any combination of one or more cameras, one or more radar sensors, one or more LIDAR sensors, and one or more ultrasonic sensors.

20. The autonomous vehicle of claim 15, wherein the sensor fusion module executes a particle filter to generate the sensor fusion output.
